(19) United States
(12) Patent Application Publication
(10) Pub. No.: US 2015/0082930 A1
(43) Pub. Date: Mar. 26, 2015

(54) GEAR MECHANISM AND MANUFACTURING METHOD OF GEAR MECHANISM

(71) Applicant: TOYOTA JIDOSHA KABUSHIKI KAISHA, Toyota-shi, Aichi-ken (JP)

(72) Inventor: Daisuke Okamoto, Susono-shi (JP)

(73) Assignee: TOYOTA JIDOSHA KABUSHIKI KAISHA, Toyota-shi (JP)

(21) Appl. No.: 14/384,341

(22) PCT Filed: Feb. 27, 2013
(86) PCT No.: PCT/IB2013/000340

§ 371 Date: Sep. 10, 2014

(30) Foreign Application Priority Data
Mar. 19, 2012 (JP) 2012-061516

(51) Int. Cl. F16H 55/08; B21K 1/30

(52) U.S. Cl. CPC F16H 55/08; B21K 1/305
USPC 74/458; 29/893.34

(57) ABSTRACT

In a gear mechanism that includes a gear in which a tooth trace is twisted at a predetermined angle with respect to an axial direction, a curvature radius along a line of contact at a meshing position where a line of contact does not intersect a pitch circle is formed larger than a curvature radius along a line of contact at a meshing position where a line of contact intersects a pitch circle, on a plane of action of the gear.

### BACKGROUND OF THE INVENTION

1. Field of the Invention

The invention relates to a gear mechanism that transmits power by the intermeshing of teeth. More particularly, the invention relates to a gear mechanism provided with a gear in which a tooth trace is twisted at a predetermined angle with respect to an axial direction, and to a manufacturing method of this gear mechanism.

2. Description of Related Art

Gear mechanisms are used in a variety of machines to change the direction of rotation of the axis of rotation of transmitted power, or to change the rotation speed of the power, or to change the torque. Gear mechanisms transmit power by the intermeshing of teeth, so when the teeth of one gear mesh with the teeth of another gear, or when power is transmitted while the meshing position changes, power loss or vibration and noise due to slippage or contact between the teeth inevitably ends up occurring.

Japanese Patent Application Publication No. 2008-275060 (JP 2008-275060 A) describes a gear that has undergone a crowning process in the direction of the line of meshing contact of the tooth face, and a crowning process to the addendum and the dedendum to correct both the tooth profile and the tooth trace, in order to inhibit noise from being produced by meshing when torque is transmitted. By forming the tooth face is this way, even if there is a fluctuation in the torque when torque is transmitted, fluctuation in extreme vibratory force of vibration is able to be inhibited. As a result, noise caused by meshing is able to be inhibited from being produced.

Also, Japanese Patent Application Publication No. 2003-184995 (JP 2003-184995 A) describes a gear that is formed such that a curvature radius near a pitch circle, or more specifically, a curvature radius of a tooth profile on a plane perpendicular to the rotational axis, is smaller than the curvature radius on an addendum side and a dedendum side of a typical reference tooth profile, and a space is formed extending through in a tooth width direction, in order to inhibit a gear that meshes with a worm gear from generating noise due to backlash. Therefore, with the gear described in JP 2003-184995 A, a tooth face elastically deforms from a load that acts thereon, so the teeth of the gear are able to mesh with the teeth of the worm gear while deforming elastically. Accordingly, the backlash amount of the gear can be reduced, which enables the generation of noise caused by meshing to be suppressed. Also, making the curvature radius near the pitch circle smaller than the curvature radius of the addendum and the dedendum enables the contact area between the worm gear and the gear to be as close to the pitch circle as possible, so wear of the tooth due to meshing is able to be suppressed.

However, because the gear rotates and transmits power while changing the contact position, slippage inherently occurs at the contact position of the tooth face. This slippage results in friction loss, which may result in reduced power transfer efficiency or damage to the tooth face. Therefore, as described in Japanese Patent Application Publication No. 2011-122617 (JP 2011-122617 A), the contact portion is typically lubricated with a lubricant such as oil. That is, a typical gear is configured to inhibit a reduction in power transfer efficiency and a reduction in friction loss due to a decrease in the friction coefficient of the contact surface, by forming a lubricant film on the contacting surface by lubricating the contact portion of the gear.

As described in Japanese Patent Application Publication No. 2008-275060 (JP 2008-275060 A), performing a crowning process in the direction of the line of meshing contact of the tooth makes it possible to inhibit the contact between gears when the gears are in mesh from becoming partial contact, and as a result, the generation of noise from meshing is able to be suppressed. However, the curvature radius at the line of contact is reduced as a result of the crowning process, so Hertzian pressure that is inversely proportionate to the curvature radius may end up increasing. Also, as described in JP 2003-184995 A, when the curvature radius near the pitch circle is reduced as well, the Hertzian pressure may end up increasing, just as with the gear described in JP 2008-275060 A.

### SUMMARY OF THE INVENTION

The invention thus provides a gear mechanism and a manufacturing method thereof, capable of suppressing or preventing an increase in friction loss due to slippage between tooth faces.

A first aspect of the invention relates to a gear mechanism that includes a gear in which a tooth trace is twisted at a predetermined angle with respect to an axial direction, a first curvature radius along a first line of contact at a meshing position where a line of contact does not intersect a pitch circle being larger than a second curvature radius along a second line of contact at a meshing position where a line of contact intersects a pitch circle, on a plane of action of the gear.

In the gear mechanism according to the first aspect, the gear mechanism may include another gear that meshes, with the gear. At least one of the first curvature radius and the second curvature radius may include a relative curvature radius calculated based on the at least one of the first curvature radius and the second curvature radius along the line of contact of the gear and a curvature radius along a line of contact of the other gear.

In the gear mechanism according to the first aspect, a third curvature radius may be larger than a fourth curvature radius. The third a curvature radius may be a curvature radius along a third line of contact at a meshing position at which a percentage by which an integrated value of a slip speed on a line of contact increases due to lengthening a line of contact is larger than a percentage by which a friction coefficient decreases due to lengthening a line of contact. The fourth curvature radius may be a curvature radius along a fourth line of contact at a meshing position at which a percentage by which an integrated value of a slip speed on a line of contact increases due to lengthening a line of contact is smaller than a percentage by which a friction coefficient decreases due to lengthening a line of contact.

In the gear mechanism according to the first aspect, the percentage by which the friction coefficient decreases due to lengthening a line of contact may be set based on a state of a tooth face of the gear.

In the gear mechanism described above, the percentage by which the friction coefficient decreases due to lengthening a line of contact may be large when a surface texture or a surface roughness of the tooth face of the gear is good, and may be small when the surface texture and the surface roughness of the tooth face of the gear is poor.

The gear mechanism described above may also include another gear that meshes with the gear, and at least one of the first, second, third and fourth curvature radii may include a relative curvature radius calculated based on the at least one of the first, second, third and fourth curvature radii along the line of contact of the gear and a curvature radius along a line of contact of the other gear.

A second aspect of the invention relates to a manufacturing method of a gear mechanism that includes a gear in which a tooth trace is twisted at a predetermined angle with respect to an axial direction. The manufacturing method includes forming the gear in which a first curvature radius along a first line of contact at a meshing position where a line of contact does not intersect a pitch circle is larger than a second curvature radius along a second line of contact at a meshing position where a line of contact intersects a pitch circle, on a plane of action of the gear, by forging.

In the manufacturing method according to the second aspect, the gear mechanism may include another gear that meshes with the gear, and at least one of the first curvature radius and the second curvature radius may include a relative curvature radius calculated based on the at least one of the first curvature radius and the second curvature radius along a line of contact of the gear and a curvature radius along a line of contact of the other gear.

In the manufacturing method according to the second aspect, a third curvature radius may be formed larger than a fourth curvature radius. The third a curvature radius may be a curvature radius along a third line of contact at a meshing position at which a percentage by which an integrated value of a slip speed on a line of contact increases due to lengthening a line of contact is larger than a percentage by which a friction coefficient decreases due to lengthening a line of contact. The fourth curvature radius may be a curvature radius along a fourth line of contact at a meshing position at which a percentage by which an integrated value of a slip speed on a line of contact increases due to lengthening a line of contact is smaller than a percentage by which a friction coefficient decreases due to lengthening a line of contact.

In the manufacturing method described above, the percentage by which the friction coefficient decreases due to lengthening the line of contact may be set based on a state of a tooth face of the gear.

In the manufacturing method described above, the percentage by which the friction coefficient decreases due to lengthening the line of contact may be set large when a surface texture or a surface roughness of the tooth face of the gear is good, and may be set small when the surface texture or the surface roughness of the tooth face of the gear is poor.

In the manufacturing method described above, the gear mechanism may include another gear that meshes with the gear, and at least one of the first, second, third and fourth curvature radii may include a relative curvature radius calculated based on the at least one of the first, second, third and fourth curvature radii along the line of contact of the gear and a curvature radius along a line of contact of the other gear.

According to first and second aspects of the invention, a gear in which a tooth trace is twisted at a predetermined angle with respect to an axial direction is provided, and a curvature radius along a line of contact at a meshing position where a line of contact does not intersect a pitch circle is formed larger than a curvature radius along a line of contact at a meshing position where a line of contact intersects a pitch circle, on a plane of action of the gear. Therefore, the Hertzian stress that acts on the tooth face is able to be reduced at a location where the curvature radius is formed large. Also, the friction coefficient is able to be reduced based on the length of the line of contact that becomes longer according to an increase in the curvature radius. As a result, even if the slip speed on the line of contact increases due to the length of the line of contact increasing, an increase in friction loss can be suppressed or prevented, or friction loss can be reduced.

Also, a curvature radius along a line of contact at a meshing position at which a percentage by which an integrated value of a slip speed on a line of contact increases due to lengthening the line of contact is larger than a percentage by which a friction coefficient decreases due to lengthening the line of contact, may be larger than a curvature radius along a line of contact at a meshing position at which a percentage by which an integrated value of a slip speed on a line of contact increases due to lengthening the line of contact is smaller than a percentage by which a friction coefficient decreases due to lengthening the line of contact. Therefore, it is possible to increase only the curvature radius at a meshing position where the friction loss will not increase even if the length of the line of contact is not increased, and as a result, the Hertzian stress that acts on the tooth face can be reduced without increasing the friction loss or while reducing the friction loss.

Furthermore, the percentage by which the friction coefficient decreases due to lengthening the line of contact may be large when a surface texture or a surface roughness of the tooth face of the gear is good, and may be small when the surface texture and the surface roughness of the tooth face of the gear is poor, so the position that increases the line of contact is able to be changed based on the surface texture and the surface roughness. As a result, the Hertzian stress that acts on the tooth face can be reduced without further increasing the friction loss or while reducing the friction loss.

Also, the curvature radius includes a relative curvature radius calculated based on the curvature radius along a line of contact of each of the pair of gears, so an increase in friction loss can be suppressed or prevented, or friction loss can be reduced, and the Hertzian stress can be reduced, without excessively increasing the curvature radius of each gear.

Further, manufacturing the gear mechanism by forging enables the forming cost for forming the tooth surface configuration, and the man-hours for machining to be reduced.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1A is a view for illustrating a relative curvature radius on a line of contact at each meshing position in a direction in which meshing advances (i.e., a meshing advancing direction), and illustrating a relative curvature radius of a gear mechanism according to an embodiment of the invention;

FIG. 1B is a view for illustrating a relative curvature radius on a line of contact at each meshing position in a direction in which meshing advances (i.e., a meshing advancing direction), and a relative curvature radius of a gear mechanism according to related art;

FIGS. 2A-C are views illustrating changes in slip speed on each line of contact in FIGS. 7B-7D;

FIG. 3 is a graph of an example in which the meshing position that increases the relative curvature radius changes according to a surface texture and surface roughness of the tooth face;

FIG. 4 is a graph of an example in which an upper limit value of a relative curvature radius is set according to the specifications of the gear;

FIG. 5 is a view of an example of the structure of a helical gear;

FIG. 6 is a schematic of a plane of action of gears that transmit power from one to the other;

FIG. 7A is a perspective view of a helical gear to which the gear mechanism according to an embodiment of the invention may be applied;

FIG. 7B is a sectional view taken along line B-B in FIG. 7A;

FIG. 7C is a sectional view taken along line C-C in FIG. 7A;

FIG. 7D is a sectional view taken along line D-D in FIG. 7A; and

FIG. 8 is a view of meshing positions on the plane of action of the gear shown in FIGS. 7A-7D.

### DETAILED DESCRIPTION OF EMBODIMENTS

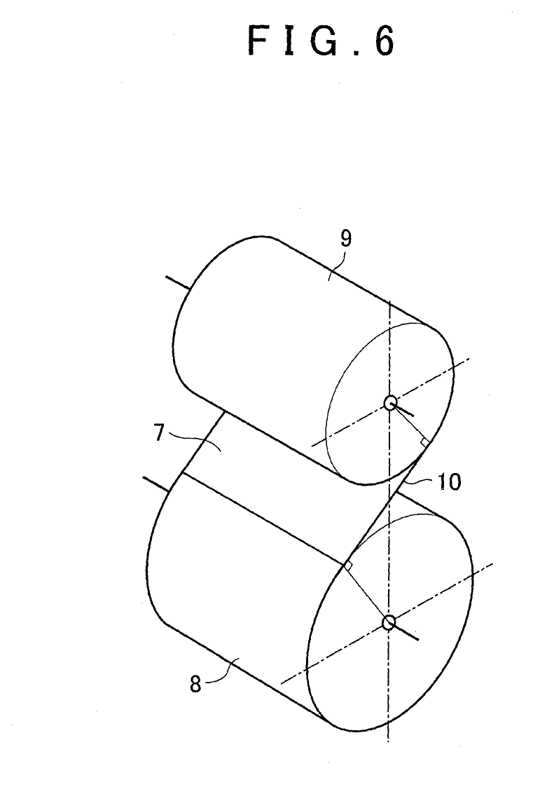

First, the basic structure of a gear to which the gear mechanism according to an embodiment of the invention may be applied will be briefly described with reference to FIGS. 5 and 6. The gear mechanism according to an embodiment of the invention may be applied to a gear 1 such as a helical gear or double helical gear or a worm gear shown in FIG. 5, in which a line of intersection of a tooth face 2 and a pitch surface 3 of the gear 1, i.e., a tooth trace 4, is twisted (i.e., skewed) at a predetermined angle (hereinafter, referred to as “twist angle θ”) with respect to an axial direction. That is, the gear mechanism of the invention may be applied to a gear in which the teeth are formed continuously twisted in the circumferential direction along a central axis s. The pitch surface 3 is a cylindrical surface where gears that transmit power contact each other as they rotate. Therefore, when the position where the gears contact each other is on the pitch surface 3, slippage does not occur between the tooth faces. Also, the line of intersection of the tooth face 2 and a given plane 5 that is perpendicular to the rotational axis, i.e., a tooth profile 6, is formed so as to be an involute curve, such that the gears will constantly be in mesh and transmit power. That is, the tooth profile 6 is formed such that the meshing position of the gears (i.e., the position where the gears mesh each other) changes continuously on a plane of action 7.

The plane of action 7 is a plane 7 that contacts both base cylinders 8 and 9 of the gears, as shown in FIG. 6, and intersects, between the gears, planes that pass through the rotational axes of the gears. A driving gear and a driven gear are in mesh on this plane of action 7. Also, a line 10 that contacts both of the base cylinders 8 and 9 on this plane of action 7, in other words, a line that is perpendicular to the rotational axis on the plane of action 7, is a line of action 10. The gears 1 in which the tooth trace 4 is twisted with respect to the axial direction start to mesh from the dedendum side (i.e., the inside of the gear tooth in a radial direction) or the addendum side (i.e., the outside of the gear tooth in a radial direction) on one end portion side in the axial direction on the plane of action 7, and transmit power while changing the meshing position toward the addendum side or the dedendum side in the axial direction. In the description below, the direction in which the meshing position changes will be referred to as the “meshing advancing direction”.

Also, with the gear mechanism, in order for a pair of gears to mesh with each other and transmit power, the tooth face of each gear elastically deforms when transmitting power so as to become a generally elliptically-shaped contact surface. This is because the curvature of the tooth face 2 in the tooth trace direction differs from the curvature of the tooth face 2 in a direction perpendicular to this tooth trace direction. If the curvature of the tooth face 2 in the tooth trace direction were the same as the curvature of the tooth face 2 in the direction perpendicular to the tooth trace direction, the contact surface would be circular. Also, the gear 1 in which the tooth trace 4 is twisted at a predetermined angle with respect to the axial direction contacts the other gear with a long axis of the elliptically-shaped contact surface being inclined at a predetermined angle with respect to the meshing advancing direction. In the description below, the long axis of the contact surface will be referred to as a “line of contact”. Also, with a helical gear, adjacent teeth make contact simultaneously on the same plane of action 7.

Here, friction loss W that occurs due to slippage between tooth faces of the gears when they transmit power, and pressure that acts on the contact surface of each tooth face, i.e., Hertzian stress σ, will be described. The friction loss W that acts on the tooth face 2 of the gear 1 occurs based on a slip speed ΔV of slippage on the line of contact that occurs between the tooth face of one gear and the tooth face of another gear that is in mesh with the one gear and transmits power. Also, the slip speed ΔV changes according to the distance from a pitch circle p that is a line of intersection of the pitch surface 3 and a plane 5 that is perpendicular to the rotational axis, to the contact position. Therefore, with a gear in which the tooth trace 4 is twisted at a predetermined angle with respect to the axial direction, the position of any line of contact is located away from the pitch circle p, so slippage occurs at each contact position, and thus friction loss W occurs. The friction loss W can be obtained by multiplying a friction coefficient μ of the tooth face by an integrated value that is a value obtained by multiplying an absolute value of a slip speed ΔV that can be calculated from the difference between a speed V1 of one gear and a speed V2 of another gear, by a load P that acts on the tooth face. An expression for calculating the friction loss W is shown below.

W=μΣP|ΔV| (1)

Also, the Hertzian stress σ that acts on the tooth face 2 of the gear 1 changes inversely proportionately to the curvature radius of a contact location, or more specifically, to a relative curvature radius ρ in a direction along a line of contact of tooth faces of intermeshing gears. If excessive Hertzian stress σ acts on the tooth face 2, the tooth face 2 may be damaged. The relative curvature radius ρ can be obtained according to the expression below.

ρ=(ρ1×ρ2)/(ρ1+ρ2) (2)

The term ρ1 in Expression (2) is the curvature radius on the line of contact of the tooth face of one of two intermeshing gears, and the term ρ2 is the curvature radius on the line of contact of the tooth face of the other of the intermeshing gears.

As described above, the Hertzian stress σ is inversely proportionate to the relative curvature radius ρ, so the Hertzian stress σ that acts on the tooth face 2 is able to be reduced by increasing the relative curvature radius ρ. That is, the Hertzian stress σ that acts on the tooth face 2 is able to be reduced by increasing one or both of the curvature radii ρ1 and ρ2 of the tooth face of the intermeshing gears. On the other hand, if the curvature radii ρ1 and ρ2 of the tooth face 2 are increased, a length 2a of the line of contact will become longer, so the friction loss W will end up increasing due to an increase in the slip speed |ΔV| according to the contact position.

Results from intense study by the inventors of the invention show that the friction coefficient μ of the contact surface of the gear 1 increases when a load N acting on the line of contact increases, and decreases when the length 2a of the line of contact increases. In other words, it is evident that the friction coefficient μ decreases when a load (N/2a) per unit length on the line of contact is reduced. With a helical gear, the load N that acts on the line of contact is a load that acts on one tooth, of a plurality of meshed teeth on the plane of action 7, i.e., that acts on one line of contact. Therefore, the gear mechanism according to the invention is configured to increase the relative curvature radius ρ at a contact position at which the percentage by which the friction loss W ends up increasing as a result of an integrated value Σ|ΔV| of the slip speed |ΔV| increasing due to the length 2a of the line of contact being increased, is less than the percentage by which the friction loss W decreases as a result of the friction coefficient μ decreasing due to the length 2a of the line of contact being increased.

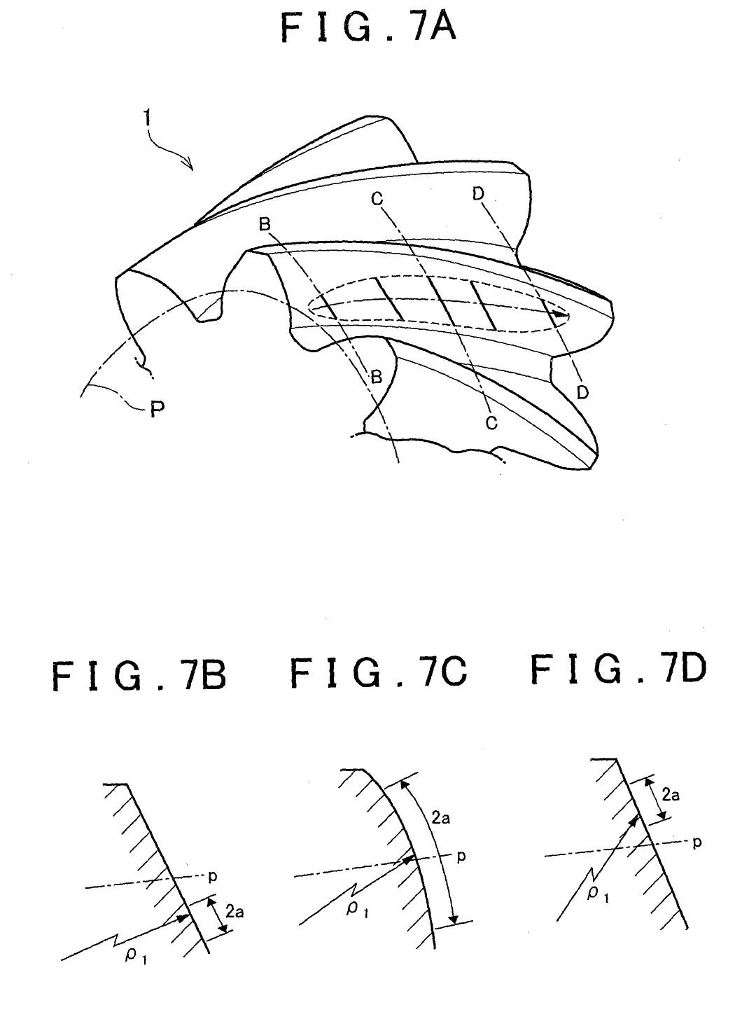

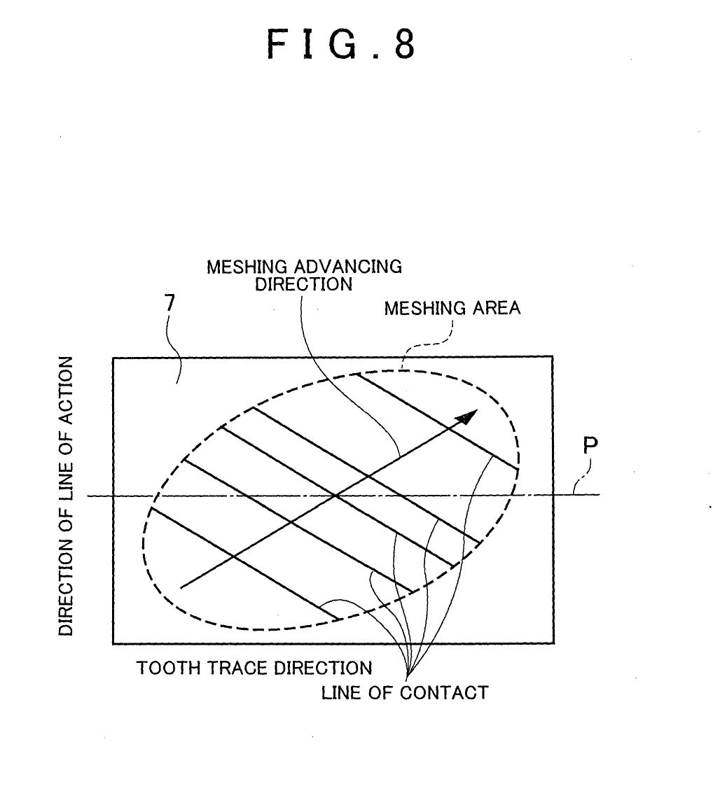

Here, one example of the structure of the gear mechanism of the invention will be described in detail using the helical gear 1 shown in FIG. 7A as an example. The helical gear 1 shown in FIG. 7A is formed so as to start to mesh from the dedendum side of one end portion side as shown by the arrow in FIG. 7A, and transmit power while changing the meshing position to the addendum side of the other end portion side. That is, the arrow in FIG. 7A points in the meshing advancing direction described above. FIG. 8 is a view of the plane of action 7 of this gear. The horizontal axis in FIG. 8 represents the tooth trace direction, and the vertical axis represents the direction of the line of action. The side below the vertical axis is the dedendum side, and the side above the vertical axis is the addendum side. Also, the solid lines in FIG. 8 represent the line of contact, the broken line represents the meshing area, the alternate long and short dash line represents the pitch circle p, and the arrow indicates the meshing advancing direction. As shown in FIG. 8, the line of contact is at a predetermined angle with respect to the meshing advancing direction and the pitch circle p. Power is transmitted by the line of contact changing continuously along the meshing advancing direction. That is, in the example shown in FIG. 8, meshing starts from the dedendum side. When the gears are in mesh on the dedendum side in this way, the line of contact does not intersect the pitch circle p. When the gears rotate and the meshing position shifts to the center portion in the tooth trace direction, the line of contact intersects the pitch circle p and power is transmitted. When the gears rotate further and the meshing position shifts to the addendum side, power is transmitted without the line of contact intersecting the pitch circle p.

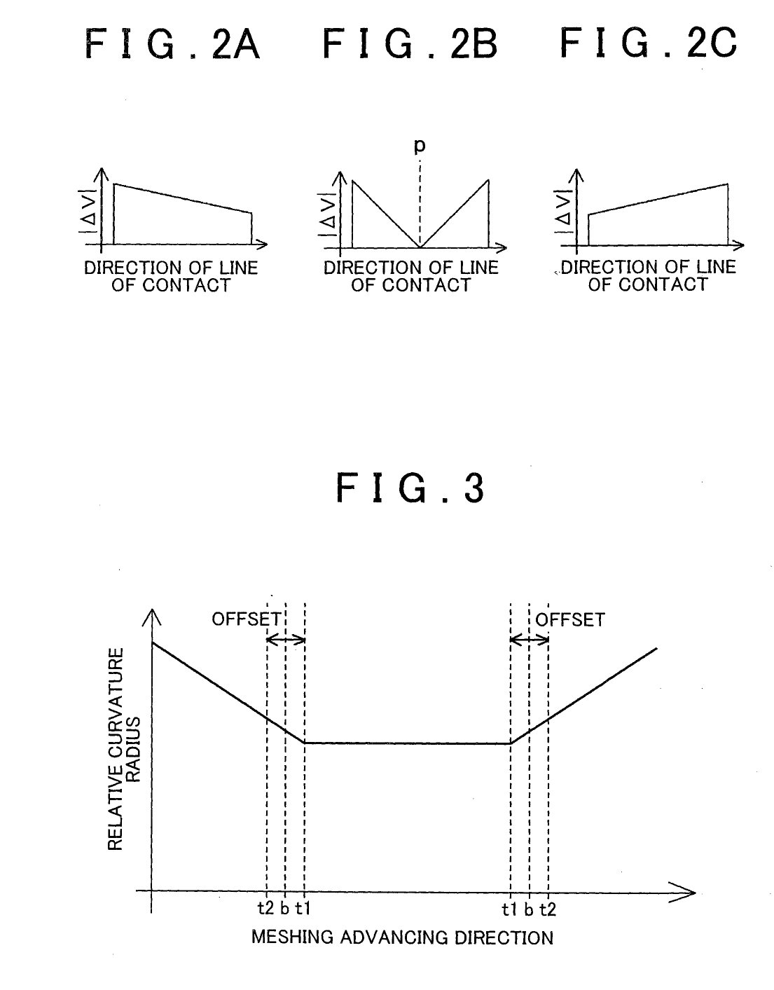

FIGS. 2A-C are views showing the changes in the slip speed |ΔV| on the line of contact in each meshing position in FIG. 8. The horizontal axes in FIGS. 2A-C represent a direction from the dedendum side to the addendum side at the line of contact, and the vertical axes represent the slip speed |ΔV|. Also, FIGS. 2A and 2C are views of states in which there is contact (between gears) without the line of contact intersecting the pitch circle p. That is, FIG. 2A is a view of a state in which there is contact only on the dedendum side of the pitch circle p. FIG. 2C is a view of a state in which there is contact only on the addendum side of the pitch circle p. FIG. 2B is a view of a state in which there is contact (between gears) with the line of contact intersecting the pitch circle p, i.e., a state in which there is contact on both the addendum side and the dedendum side of the pitch circle p. Therefore, in a state in which the gears are in mesh on the line of contact along line B-B in FIGS. 7A and 8, the slip speed |ΔV| at an end portion of the line of contact, which is on a side near the pitch circle p, as shown in FIG. 2A, i.e., at a position where the gears contact each other on the addendum side, is less than the slip speed |ΔV| on an end portion on a side away from the pitch circle p, i.e., at a position where the gears contact each other on the dedendum side. Also, when the gears are in mesh on the line of contact along line C-C in FIGS. 7A and 8, the slip speed |ΔV| becomes 0 (zero) on the pitch circle p, as shown in FIG. 2B, and the slip speed |ΔV| increases farther away from this pitch circle p. Moreover, when the gears are in mesh on the line of contact along line D-D in FIGS. 7A and 8, the slip speed |ΔV| at an end portion of the line of contact, which is on a side near the pitch circle p, as shown in FIG. 2C, i.e., at a position where the gears contact each other on the dedendum side, is less than the slip speed |ΔV| on an end portion on a side away from the pitch circle p, i.e., at a position where the gears contact each other on the addendum side.

Therefore, the friction loss W when the gears are in mesh on the line of contact is proportionate to the integrated value of the slip speed |ΔV| shown in FIGS. 2A-C, so by increasing the length 2a of the line of contact, the slip speeds |ΔV| at both end portions of the line of contact end up increasing when the gears contact each other as shown in FIG. 2B. As a result, the percentage by which the friction loss W increases due to the integrated value of the slip speed |ΔV| increasing becomes larger than the percentage by which the friction loss W decreases due to the friction coefficient μ decreasing, so the relative curvature radius ρ is unable to be increased at a meshing position where the line of contact intersects the pitch circle p.

Also, as shown in FIGS. 2A and 2C, when the tooth face is in contact at a location where the line of contact does not intersect the pitch circle p, the slip speed |ΔV| on the side of the line of contact that is away from the pitch circle p increases and the slip speed |ΔV| on the side of the line of contact that is near the pitch circle p decreases, by increasing the length 2a of the line of contact. Therefore, the percentage by which the friction loss W increases due to the integrated value of the slip speed |ΔV| increasing becomes less than the percentage by which the friction loss W decreases due to the friction coefficient μ decreasing. In other words, the percentage by which the friction loss W decreases due to the friction coefficient μ decreasing increases with respect to the percentage by which the friction loss W increases due to the integrated value of the slip speed |ΔV| increasing. Therefore, at a meshing position where the line of contact does not intersect the pitch circle p, the relative curvature radius ρ is increased in the direction of the line of contact. Thus, the tooth surface configuration at a cross-section taken along line C-C is generally arc-shaped with a small curvature radius as shown in FIG. 7C, and the tooth surface configuration at a cross-section taken along line D-D is generally linear with a large curvature radius as shown in FIG. 7D.

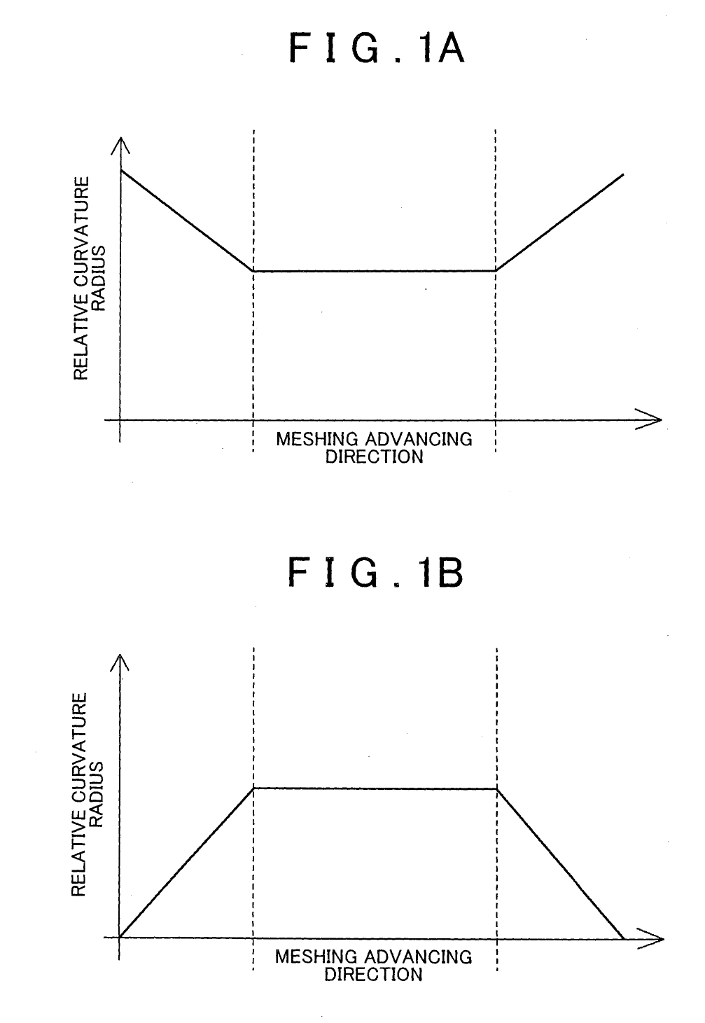

Also, FIGS. 1A and 1B are views of the relative curvature radius ρ on the line of contact at each meshing position in the meshing advancing direction, with FIG. 1A being a view of the relative curvature radius ρ of the gear mechanism according to the invention, and FIG. 1B being a view of the relative curvature radius ρ of a gear mechanism according to related art. The horizontal axes in FIGS. 1A and 1B represent the meshing advancing direction, and the vertical axis represents the relative curvature radius ρ. As shown in FIGS. 1A and 1B, the relative curvature radius ρ at a meshing position where the line of contact of the gear mechanism according to the related art intersects the pitch circle p is the same as the relative curvature radius ρ of a meshing position where the line of contact of the gear mechanism of the invention intersects the pitch circle p. However, regarding a meshing position where the line of contact does not intersect the pitch circle p, the gear mechanism according to the related art is formed such that the relative curvature radius ρ decreases toward both end portions in the meshing advancing direction, while the gear mechanism according to the invention is formed such that the relative curvature radius ρ increases toward both end portions in the meshing advancing direction.

Accordingly, with the gear mechanism according to related art, the Hertzian stress σ of a meshing position where the line of contact does not intersect the pitch circle p ends up increasing. However, the Hertzian stress σ that acts on the tooth face is able to be reduced, without increasing the friction loss W or while reducing the friction loss W, by increasing the relative curvature radius ρ at a meshing position where the friction loss W will not increase even if the length 2a of the line of contact is increased as described above, i.e., at a meshing position where the line of contact does not intersect the pitch circle p.

In FIG. 1, the gear mechanism is formed such that the relative Curvature radius ρ proportionately increases toward both end portions in the meshing advancing direction. However, the gear mechanism according to the invention may also be formed such that the relative curvature radius ρ at a meshing position where the line of contact does not intersect the pitch circle p increases in a parabolic shape. In other words, the gear mechanism of the invention need simply be formed such that the relative curvature radius ρ increases.

Also, results from intense study by the inventors of the invention show that the percentage of change in the friction coefficient μ due to a change in the length 2a of the line of contact changes according to the state of the tooth face at a meshing position, such as the surface texture and the surface roughness of the tooth face. That is, it is evident that when at least one, of the surface texture and the surface roughness of the tooth face is improved, the percentage of decrease in the friction coefficient μ with respect to the percentage that increases the length 2a of the line of contact increases. Therefore, when the surface texture or the surface roughness is good, even at a meshing position where the line of contact intersects the pitch circle p, the percentage by which the friction loss W decreases due to the friction coefficient μ decreasing may be larger than the percentage by which the friction loss W increases due to the length 2a of the line of contact being increased. Conversely, when the surface texture or the surface roughness is poor, even at a meshing position where the line of contact does not intersect the pitch circle p, the percentage by which the friction loss W decreases due to the friction coefficient μ decreasing may be smaller than the percentage by which the friction loss W increases due to the length 2a of the line of contact being increased. Therefore, the gear mechanism according to the invention is formed such that the meshing position where the relative curvature radius ρ increases changes along the meshing advancing direction based on the state of the tooth face such as the surface texture and the surface roughness.

More specifically, as shown in FIG. 3, when the surface texture and the surface roughness are good, the meshing position changes from a boundary position b between a meshing position where the line of contact intersects the pitch circle p and a meshing position where the line of contact does not intersect the pitch circle p toward the side with the meshing position where the line of contact intersects the pitch circle p. Also, when the surface texture and the surface roughness are poor, the meshing position changes from the boundary position b toward the side with the meshing position where the line of contact does not intersect the pitch circle p. More specifically, when the surface texture and the surface roughness are good, the meshing position that increases the length 2a of the line of contact changes toward the side with the meshing position where the line of contact intersects the pitch circle p, up to a meshing position where the percentage by which the friction loss W decreases due to the friction coefficient μ that takes the surface texture and surface roughness into account decreasing becomes larger than the percentage by which the friction, loss W increases due to the length 2a of the line of contact being increased. That is, the meshing position that increases the length 2a of the line of contact changes from point b to point t1 in FIG. 3. Conversely, when the surface texture and the surface roughness are poor, the meshing position that increases the length 2a of the line of contact changes toward the side with the meshing position where the line of contact does not intersect the pitch circle p, up to a meshing position where the percentage by which the friction loss W decreases due to the friction coefficient μ that takes the surface texture and surface roughness into account decreasing becomes larger than the percentage by which the friction loss W increases due to the length 2a of the line of contact being increased. That is, the meshing position that increases the length 2a of the line of contact changes from point b to point t2 in FIG. 3.

Changing the meshing position that increases the length 2a of the line of contact according to the surface texture and the surface roughness in this way makes it possible to further reduce the Hertzian stress σ that acts on the tooth face 2, without increasing the friction loss W or while reducing the friction loss W.

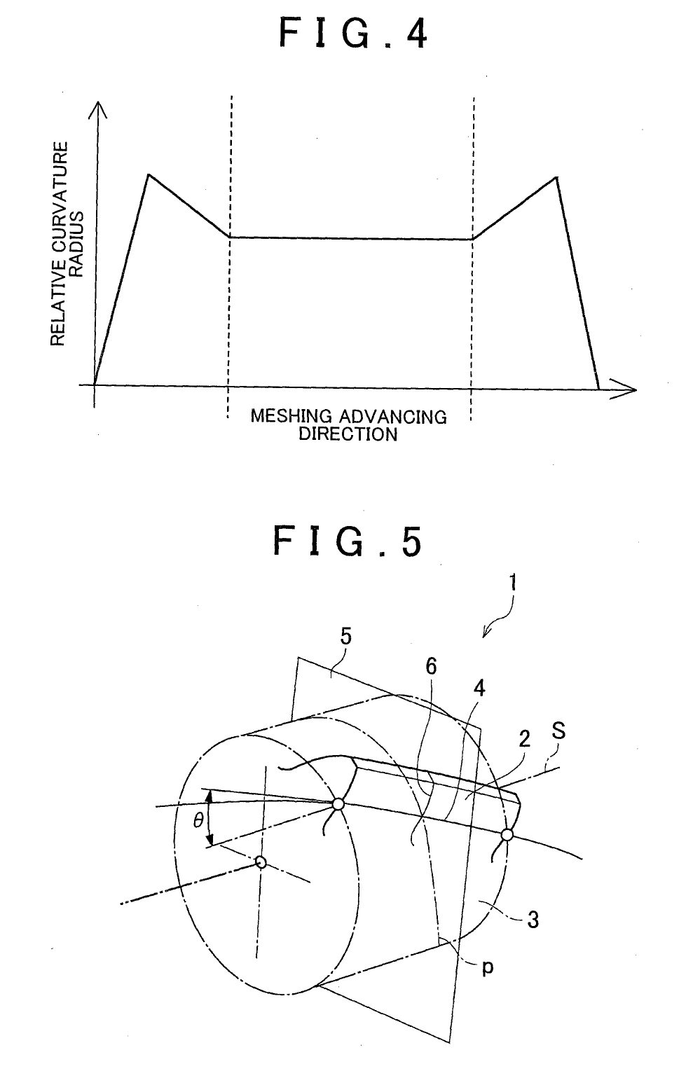

However, if there are mounting restrictions on the tooth width of the gear 1, the relative curvature radius ρ may not be able to be increased along the entire meshing area. Therefore, with the gear mechanism according to the invention, the shape is set by setting a rate of change of the relative curvature radius ρ in the meshing advancing direction based on the specifications of the gear 1, such as the tooth width and twist angle θ of the gear 1, and then back-calculating an upper limit value of the relative curvature radius ρ that can be increased to reduce the friction loss W, from this rate of change of the relative curvature radius ρ. FIG. 4 is a view showing the change in the relative curvature radius ρ in the meshing advancing direction when the gear mechanism is formed by back-calculating the upper limit value of the relative curvature radius ρ. As shown in FIG. 4, both end portions in the meshing advancing direction are formed such that the relative curvature radius ρ there is 0 (zero) and then increases from both end portions toward the center portion. The upper limit value of, the relative curvature radius ρ and the rate of change that increases the relative curvature radius ρ from both end portions toward the center portion are set according to the specifications of the gear 1. Moreover, the relative curvature radius ρ on both end portion sides in the meshing advancing direction is increased from a meshing position where the percentage by which the friction loss W increases due to the slip speed |ΔV| increasing as a result of the length 2a of the line of contact being increased matches the percentage by which the friction loss W decreases due to the friction coefficient μ decreasing as a result of the length 2a of the line of contact being increased.

Setting the upper limit value of the relative curvature radius ρ based on the specifications of the gear 1, such as the tooth width and the twist angle θ, and then setting the relative curvature radius ρ on the line of contact in this way makes it possible to reduce the Hertzian stress σ that acts on the tooth face 2, without increasing the friction loss W or while reducing the friction loss W, while maintaining the mountability of the gear 1.

As described above, the gear mechanism according to the invention need simply be formed with the relative curvature radius ρ at a meshing position where the line of contact on the plane of action 7 does not intersect the pitch circle p being larger than the relative curvature radius ρ at a meshing position where the line of contact intersects the pitch circle p. Therefore, the gear mechanism may be configured such that the relative curvature radius ρ increases by increasing one of the curvature radii ρ1 or ρ2 of the intermeshed gears, or the gear mechanism may be configured such that the relative curvature radius ρ increases by increasing both of the curvature radii ρ1 and ρ2 of the intermeshed gears. In particular, configuring the gear mechanism such that the relative curvature radius ρ increases by increasing both of the curvature radii ρ1 and ρ2 of the intermeshed gears makes it possible to increase the relative curvature radius ρ without excessively increasing the curvature radii ρ1 and ρ2 of the gears, so it is preferable to increase both the curvature radii ρ1 and ρ2 of the gears. Also, the gear mechanism may also be applied to a gear formed such that the meshing position changes from the addendum side to the dedendum side along the axial direction.

Also, a gear formed such that the tooth profile is an involute curve is typically formed by a generation cutting process using a rack tool, but the gear 1 formed as described above is formed with the curvature radius changing in the direction of the line of contact. Therefore, when forming the gear 1 by the generation cutting process, secondary processing is necessary or adjustment of the rack tool and the like is difficult, which may end up increasing the number of man-hours for machining and increasing the forming cost. Thus, the gear mechanism according to the invention is formed by a forging method that forms the gear mechanism by plastic-flowing metal material by applying pressure with a mold or the like.

Moreover, with the gear 1 described above, the tooth surface configuration can be measured by a three-dimensional measuring instrument or the like, and the line of contact and the curvature radius on this line of contact can be analyzed or calculated based on this measurement value, for example. In this case, the tooth surface configuration is preferably measured based on an acceptable value specified in Japanese Industrial Standards (JIS B 1702-1 or JIS B 1702-2). The Japanese Industrial Standards (JIS B 1702-1 or JIS B 1702-2) correspond to the regulations of the International Organization for Standardization (ISO 1328-1 or ISO 1328-2).

1. A gear mechanism comprising:
a helical gear in which a first curvature radius along a first line of contact at a meshing position where a line of contact does not intersect a pitch circle is larger than a second curvature radius along a second line of contact at a meshing position where a line of contact intersects a pitch circle, on a plane of action of the helical gear.

2. The gear mechanism according to claim 1, further comprising another gear that meshes with the helical gear,
wherein at least one of the first curvature radius and the second curvature radius includes a relative curvature radius calculated based on the at least one of the first curvature radius and the second curvature radius and a curvature radius along a line of contact of the other gear.

3. The gear mechanism according to claim 1, wherein a third curvature radius on the plane of action of the helical gear is larger than a fourth curvature radius on the plane of action of the helical gear,
the third curvature radius is a curvature radius along a third line of contact at a meshing position at which a percentage by which an integrated value of a slip speed on a line of contact increases due to lengthening a line of contact is larger than a percentage by which a friction coefficient decreases due to lengthening a line of contact, and
the fourth curvature radius is a curvature radius along a fourth line of contact at a meshing position at which a percentage by which an integrated value of a slip speed on a line of contact increases due to lengthening a line of contact is smaller than a percentage by which a friction coefficient decreases due to lengthening a line of contact.

4. The gear mechanism according to claim 3, wherein the percentage by which the friction coefficient decreases due to lengthening a line of contact is set based on a state of a tooth face of the helical gear.

5. The gear mechanism according to claim 4, wherein the percentage by which the friction coefficient decreases due to lengthening a line of contact is large when a surface texture or a surface roughness of the tooth face of the of the helical gear is good, and is small when the surface texture or the surface roughness of the tooth face of the helical gear is poor.

6. The gear mechanism according to claim 3, further comprising another gear that meshes with the helical gear,
Wherein at least one of the first, second, third and fourth curvature radii includes a relative curvature radius calculated based on the at least one of the first, second, third and fourth curvature radii along the line of contact of the helical gear and a curvature radius along a line of contact of the other gear.

7. A manufacturing method of a gear mechanism, the gear mechanism including a helical gear, the manufacturing method comprising:
forming the helical gear in which a first curvature radius along a first line of contact at a meshing position where a line of contact does not intersect a pitch circle is larger than a second curvature radius along a second line of contact at a meshing position where a line of contact intersects a pitch circle, on a plane of action of the helical gear, by forging.

8. The manufacturing method according to claim 7, wherein the gear mechanism includes another gear that meshes with the helical gear, and
at least one of the first curvature radius and the second curvature radius includes a relative curvature radius calculated based on the at least one of the first curvature radius and the second curvature radius and a curvature radius along a line of contact of the other gear.

9. The manufacturing method according to claim 7, wherein a third curvature radius on the plane of action of the helical gear is formed larger than a fourth curvature radius on the plane of action of the helical pear,
the third curvature radius is a curvature radius along a third line of contact at a meshing position at which a percentage by which an integrated value of a slip speed on a line of contact increases due to lengthening a line of contact is larger than an percentage by which a friction coefficient decreases due to lengthening a line of contact, and
the fourth curvature radius is a curvature radius along a fourth line of contact at a meshing position at which a percentage by which an integrated value of a slip speed on a line of contact increases due to lengthening a line of contact is smaller than a percentage by which a friction coefficient decreases due to lengthening a line of contact.

10. The manufacturing method according to claim 9, wherein the percentage by which the friction coefficient decreases due to lengthening the line of contact is set based on a state of a tooth face of the helical gear.

11. The manufacturing method according to claim 10, wherein the percentage by which the friction coefficient decreases due to lengthening the line of contact is set large when a surface roughness of the tooth face of the helical gear is good, and is set small when the surface texture or the surface roughness of the tooth face of the helical gear is poor.

12. The manufacturing method according to claim 9, wherein the gear mechanism includes another gear that meshes with the helical gear, and
at least one of the first, second, third and fourth curvature radii includes a relative curvature radius calculated based on the at least one of the first, second, third or fourth curvature radii along the line of contact of the helical gear and a curvature radius along a line of contact of the other gear.
